(19) United States
(12) Patent Application Publication
(10) Pub. No.: US 2025/0020230 A1
(43) Pub. Date: Jan. 16, 2025

(54) Rotating Valve System

(71) Applicant: Illinois Tool Works Inc., Glenview, IL (US)

(72) Inventors: Joseph D. Davis, Glenview, IL (US); Christopher A. Carns, Glenview, IL (US); Nathan C. Osmun, Glenview, IL (US)

(21) Appl. No.: 18/742,807

(22) Filed: Jun. 13, 2024

Related U.S. Application Data
(60) Provisional application No. 63/525,878, filed on Jul. 10, 2023.

(51) Int. Cl. F16K 27/00; F16K 31/53

(52) U.S. Cl. CPC F16K 27/003; F16K 31/535

(57) ABSTRACT

A rotating valve system assembly for an internal combustion engine cooling system. The rotating valve system assembly including a housing, a valve assembly, an actuator, and a seal. The housing includes a valve cavity and a manifold which allows fluid flow to and from the rotating valve system. The valve assembly includes one or more cartridges, which control the volume of fluid that passes through the valve. The actuator turns the cartridges by interfacing with them via a drive gear that connects with a gear portion that is included on each cartridge. As the cartridges turn, exit holes that are disposed around the circumference of the cylinder bodies may overlap, partially or wholly, with an inlet port to the manifold of the housing, which allows control of the volume of fluid that flows through the valve and into the manifold and into the outside.

### RELATED APPLICATION

The present application claims priority to U.S. Provisional Patent Application No. 63/525,878, filed Jul. 10, 2023, and entitled “Rotating Valve System” which is hereby incorporated by reference in its entirety.

### BACKGROUND

Internal combustion engines typically employ a thermal management system to ensure optimal temperature control for various components within the engine, transmission, electrical systems, and the like. Thermal management systems often include one or more coolant valves to control the flow of coolant throughout the engine and other heat-generating components.

It is also sometimes necessary to provide fluids at different volumes and speeds. To that end, it is desirable to use coolant valves that enable variable flow volumes and speeds through a pipeline or other flow path. Despite advancements, a need exists for an improved valve that can change fluid pathways and volumes as required by the vehicle's thermal management system.

### SUMMARY

The present disclosure relates generally to a rotating valve system assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a perspective view of an example rotating valve system in accordance with aspects of this disclosure.

FIG. 1b illustrates the perspective view of the example rotating valve system with components omitted to better illustrate internal components thereof.

FIG. 1c illustrates an exploded view of the example rotating valve system.

FIG. 2a illustrates a perspective view of the example valve assembly with a drive assembly.

FIG. 2b illustrates a cross-section view of a housing with a cartridge therein with an example fluid flow pattern illustrated using broken arrows.

FIG. 2c illustrates the rotating valve system during transition between a first a closed position and an open position.

FIGS. 3a and 3b illustrate first and second perspective views of an example cartridge.

FIG. 4 illustrates a cross-sectional view of the flow interface between a cartridge and the housing.

FIG. 5 illustrates an exploded view of an example drive assembly.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a rotating valve system having two or more rotating control valves that are configured to rotate to provide desired cooling paths and flow rates. In one example, a rotating valve system comprises: a housing defining a valve cavity, wherein the housing includes one or more inlet ports and one or more outlet housing ports; a valve assembly positioned within the valve cavity and configured to receive fluid via the one or more inlet ports at a first rate and to output the fluid via the one or more outlet housing ports at a second rate, wherein the valve assembly comprises a plurality of cartridges mechanically engaged with one another and each of the plurality of cartridges being configured to rotate about an axis of rotation between a first position and a second position; and a drive assembly configured to rotate the plurality of cartridges between the first position and the second position.

In another example, a valve assembly configured to receive fluid at a first rate and to output the fluid at a second rate comprises: a first cartridge; and a second cartridge mechanically engaged with the first cartridge, wherein each of the first cartridge and the second cartridge is configured to rotate about an axis of rotation between a first position and a second position; and wherein each of the first cartridge and the second cartridge comprises a gear portion and a body portion that defines an inlet port configured to receive the fluid and at least one exit hole in a sidewall of the body portion to deliver the fluid.

In another example, a rotating valve system comprises: a housing defining a valve cavity, wherein the housing includes one or more inlet ports and one or more outlet housing ports; and a valve assembly positioned within the valve cavity and configured to receive fluid via the one or more inlet ports at a first rate and to output the fluid via the one or more outlet housing ports at a second rate, wherein the valve assembly comprises a plurality of cartridges mechanically engaged with one another and each of the plurality of cartridges being configured to rotate about an axis of rotation between a first position and a second position, wherein each of the plurality of cartridges comprises a gear portion and a body portion that defines an inlet port configured to receive the fluid from the one or more inlet ports and at least one exit hole in a sidewall of the body portion configured to deliver the fluid to one of the one or more outlet housing ports.

In some examples, each of the plurality of cartridges comprises a body portion and a gear portion. The body portion defines an inlet port configured to receive the fluid from the one or more inlet ports and at least one exit hole in a sidewall of the body portion configured to deliver the fluid to one of the one or more outlet housing ports. Each cartridge can include a first bearing and/or a second bearing to support the cartridge during rotation thereof.

When in the first position, the at least one exit hole is configured to not align with any of the one or more outlet housing ports to prevent fluid flow therethrough, whereas, when in the second position, the at least one exit hole is configured to fully align with one of the one or more outlet housing ports to enable fluid flow therethrough. Each of the plurality of cartridges can be configured to rotate between the first position and the second position via one or more intermediate positions where the at least one exit hole is configured to partially align with one of the one or more outlet housing ports to enable partial fluid flow therethrough.

In some examples, a seal is positioned at a flow interface between the housing and the cartridge. The seal can comprise a PTFE ring and an annular ring. The annular ring may be configured to provide a spring force that biases the PTFE ring to maintain contact with a surface of the cartridge during rotation thereof.

In some examples, a manifold is coupled to the housing and configured to receive the fluid via the one or more outlet housing ports. In some examples, the drive assembly comprises an actuator, a driveshaft, and a drive gear. The drive gear being configured to interface with the valve assembly via a gear portion formed in or on one of the plurality of cartridges. In some examples, the drive assembly further comprises a bearing and a seal surrounding at least a portion of the driveshaft.

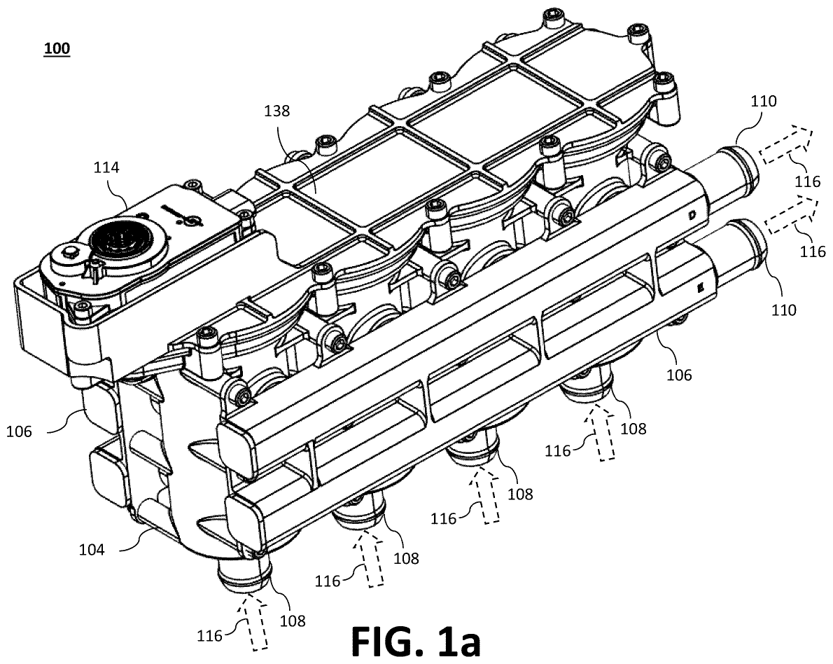

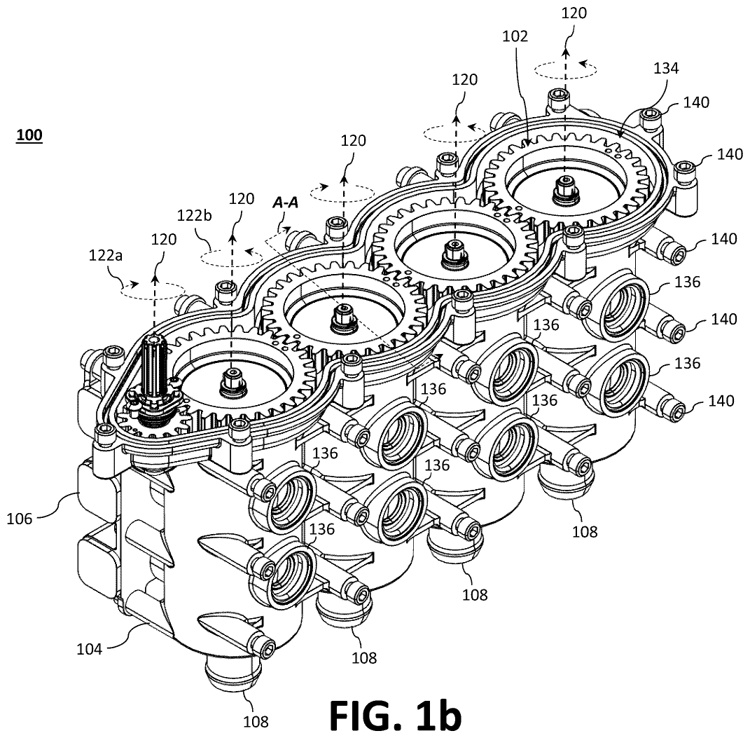

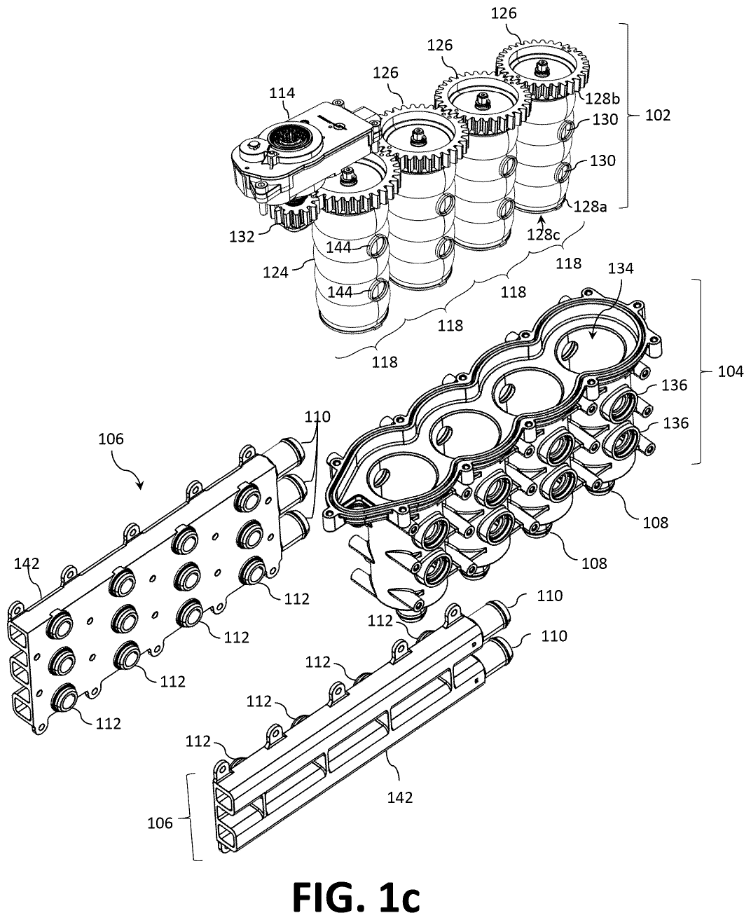

FIG. 1a illustrates a perspective view of an example rotating valve system 100 in accordance with aspects of this disclosure. FIG. 1b illustrates a perspective view of the rotating valve system 100 with components omitted to better illustrate the internal components thereof, while FIG. 1c illustrates an exploded view of the example rotating valve system 100. As illustrated, the rotating valve system 100 generally comprises a valve assembly 102, a housing 104, one or more manifolds 106, and a drive assembly 114.

In operation, fluid 116 (e.g., water, coolant, gas, etc.) enters the rotating valve system 100 at a first rate via inlet housing ports 108, passes through each of the housing 104, the valve assembly 102, the one or more manifolds 106, and then exits the rotating valve system 100 at a second rate via outlet manifold ports 110. The second rate, which is variable and can be adjusted in real-time during operation, ranges from a flow rate that is less than the first rate (including zero flow) to a flow rate that is equal to the first rate. For example, by controlling the drive assembly 114, the second rate can be adjustable between a first position (e.g., no flow—a closed position) and a second position (e.g., full flow—an open position) via various intermediate positions (e.g., reduced flow).

The valve assembly 102 comprises a plurality of cartridges 118. In the illustrated example, the valve assembly 102 comprises four cartridges 118, however, additional or fewer cartridges 118 may be used depending on design specifications, such as flow rate, flow volume, size of the rotating valve system 100, etc. Further, while the cartridges 118 are depicted in a linear arrangement (arranged in a straight line when viewed from above or below), other arrangements are contemplated including, but not limited to, a square layout, a triangular layout, a pentagon layout, etc.

Each of the plurality of cartridges 118 is configured to rotate about an axis of rotation 120 in either a first direction 122a and/or a second direction 122b. As illustrated, the axis of rotation 120 for each of the plurality of cartridges 118 within a valve assembly 102 is parallel to one another.

Each of the cartridges 118 comprises a body portion 124 and a gear portion 126. The illustrated body portion 124 is formed as a cylinder body that defines a hollow cavity 128c with an open end 128a (e.g., a first end) and a closed end 128b (e.g., a second end). The body portion 124 further defines one or more exit holes 130, which can be formed in a sidewall of the cylinder body. The open end 128a is fluidically coupled to the one or more exit holes 130 via the hollow cavity 128c such that fluid can flow into the hollow cavity 128c via the open end 128a and out of the hollow cavity 128c via the one or more exit holes 130.

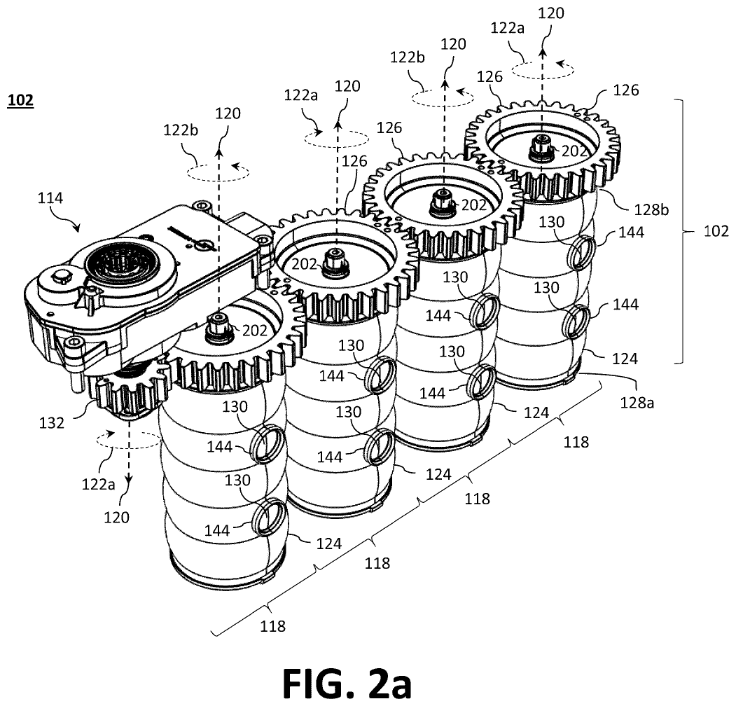

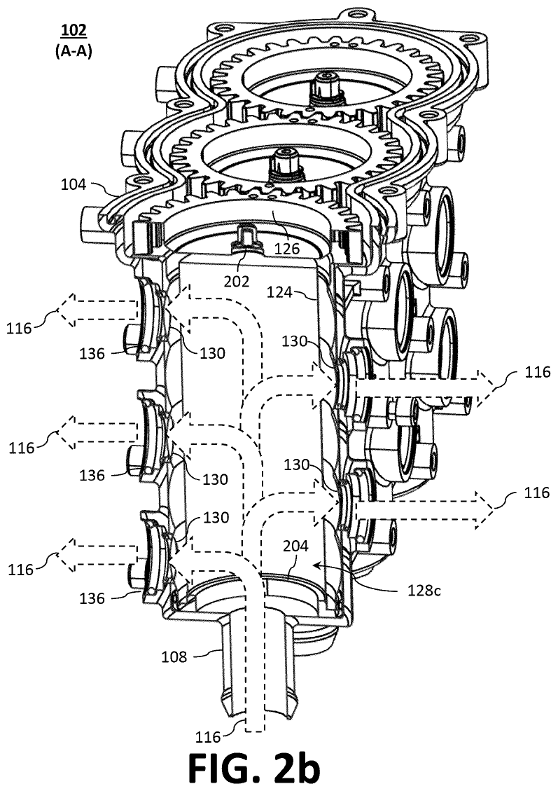

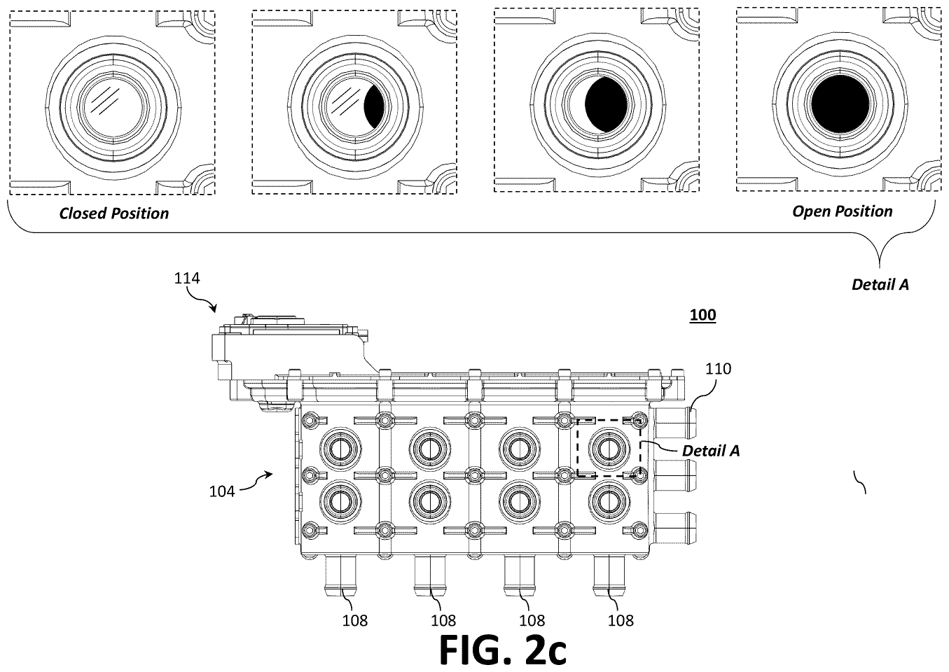

In the illustrated example, the body portion 124 defines five exit holes 130. Specifically, as will be discussed in connection with FIG. 2b, two exit holes 130 are positioned on one side of the body portion 124 and are configured to deliver fluid 116 to a first manifold 106, while three exit holes 130 are positioned on the other, opposite side of the body portion 124 and are configured to deliver fluid 116 to a second manifold 106. While each of the illustrated cartridges 118 comprises five exit holes 130, additional or fewer exit holes 130 may be used depending on design specifications, such as flow rate, flow volume, height of the body portion 124, etc. In addition, rather than being positioned and offset by 180 degrees (e.g., at opposite sides of the body portion 124), the exit holes 130 can be positioned at other locations of the body portion 124 and offset by, for example 45 to 135 degrees.

The gear portion 126, which comprises a plurality of gear teeth, is positioned or formed at or adjacent the closed end 128b of the body portion 124. In some examples, the gear portion 126 and the body portion 124 are formed as a unitary structure. For example, the body portion 124 can be formed with the gear portion 126 during a manufacturing process, such as molding, additive manufacturing, etc.

As illustrated, the cartridges 118 are configured to mechanically engage one another via the gear portions 126 to, in effect, form a gear train that is ultimately driven by the drive assembly 114. For example, as illustrated, each cartridge 118 mechanically engages one or more adjacent (e.g., neighboring) cartridges 118. In operation, the drive assembly 114 rotates the cartridges 118 by rotating a drive gear 132 that is connected to the gear train (e.g., via one of the gear portions 126).

The housing 104 includes, or otherwise defines, inter alia, a valve cavity 134, a plurality of inlet housing ports 108, and a plurality of outlet housing ports 136. The valve cavity 134 is sized and shaped to house the valve assembly 102 therein. The plurality of inlet housing ports 108 is fluidically coupled to the plurality of outlet housing ports 136 via the valve cavity 134 such that fluid can flow into the valve cavity 134 via an inlet port, through the valve assembly 102 house therein, and out of the valve cavity 134 (and valve assembly 102) via an outlet port 136.

In some examples, as illustrated, the valve assembly 102 can be sealed within the valve cavity 134 via panel or cover, such as a removable cover 138 (e.g., a lid). To that end, the housing 104 may comprise a removable cover 138 that enables access to the valve cavity 134. A removable cover 138 can be useful to facilitate repair or maintenance of, for example, the valve assembly 102. The removable cover 138 can be secured to the remainder of the housing 104 via, for example, threaded fasteners 140. A portion of the housing 104 can, therefore, be fabricated to define one or more threaded openings to engage the threaded fasteners 140. In other examples, the valve assembly 102 may be sealed within the valve cavity 134 via a permanent panel or cover, which can sealed via, for example, adhesive, ultrasonic welding, etc.

As illustrated in FIGS. 1a and 1c, the one or more manifolds 106 are fluidically coupled to the housing 104. In the illustrated example, a manifold 106 is positioned on each side of the housing 104, however, additional or fewer manifolds 106 may be used depending on design specifications, such as flow rate, flow volume, size of the rotating valve system 100, etc. For example, a single manifold 106 may be used where lower flow rates or volumes are contemplated. In either case, each manifold 106 is configured to receive fluid flow from the valve assembly 102 via the housing 104 to ultimately convey the fluid to another component, through outlet manifold ports 110.

Each manifold 106 includes, or otherwise defines, inter alia, a plurality of inlet manifold ports 112 joined to one or more outlet manifold ports 110 via one or more channels 142. The plurality of inlet manifold ports 112 is fluidically coupled to the one or more outlet manifold ports 110 via the one or more channels 142. When assembled, the manifold 106 is coupled to the housing 104 such that each of the inlet manifold ports 112 aligns with a respective one of the plurality of outlet housing ports 136 at a flow interface to facilitate fluid flow therethrough.

The housing 104, the manifolds 106, and the drive assembly 114 can be secured to one another via, for example, threaded fasteners 140. To that end, one or more of the components can be fabricated to define one or more threaded openings configured to engage a threaded fastener 140. One or more seals 144 can be positioned at the various flow interfaces between the cartridges 118, the housing 104, and/or the manifolds 106. In some examples, a seal 144 is positioned at the flow interfaces between each inlet manifold port 112 and its corresponding outlet housing port 136. The seal 144 can be positioned in or on one or more of the exit holes 130, the inlet manifold port 112, and the outlet housing port 136.

One or more components of the rotating valve system 100 (e.g., the housing 104, a valve assembly 102, one or more manifolds 106, and a drive assembly 114) can be fabricated from a plastic material using a plastic injection technique, additive manufacturing, or otherwise. In some examples, one or more components of the rotating valve system 100 can be formed using metal or other metallic material. In some examples, one or more components of the rotating valve system 100 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

FIG. 2a illustrates a perspective view of the example valve assembly 102 and an attached drive assembly 114. FIG. 2b illustrates a cross-section view of a housing 104 with a cartridge 118 of the valve assembly 102 positioned therein. FIG. 2c illustrates transition of the rotating valve system 100 between a first position (e.g., no flow—a closed position) and a second position (e.g., full flow—an open position) via intermediate positions (e.g., intermediate flow/reduced flow). For illustrative purposes, the manifolds are omitted from FIGS. 2b and 2c.

As illustrated in FIG. 2a, the drive assembly 114 is configured to drive/rotate each of the plurality of cartridges 118 about an axis of rotation 120. In the illustrated example, the drive assembly 114 is configured to output a rotational force to drive a drive gear 132, thus rotating the drive gear 132 about an axis of rotation 120 in a first direction 122a. The drive gear 132 is mechanically engaged with the gear train formed by the meshed gear portions 126 of the plurality of cartridges 118. The drive assembly 114 is, therefore, configured to rotate each of the cartridges 118 about the axis of rotation 120 in either the first direction 122a or the second direction 122b.

Each cartridge 118 is rotatably supported and guided during rotation within the valve cavity 134 by one or more bearings, such as a first bearing 202 positioned at the closed end 128b of the cartridge 118 (e.g., at or adjacent the gear portion 126) and a second bearing 204 positioned at the open end 128a of the cartridge 118. Each of the first bearing 202 and the second bearing 204 serve to, inter alia, stabilize and reduce friction during rotation of the cartridge 118.

With reference to FIG. 2b, fluid 116 enters the hollow cavity 128c via the inlet port 108 and exits the hollow cavity 128c via the one or more exit holes 130 which, depending on the rotational position of the cartridge 118 within the valve cavity 134, may or may not be aligned with the outlet housing port 136.

With reference to FIG. 2c, by controlling the drive assembly 114, the rotational position of the cartridge 118 within the valve cavity 134 can be adjusted between a first position (e.g., no flow—a closed position) and a second position (e.g., full flow—an open position) via various incremental intermediate positions (e.g., reduced flow rates). In other words, the exit holes 130 may be selectively aligned, whether partially or wholly, with the outlet housing port 136 to adjust the flow rate through the rotating valve system 100 between the first position (e.g., no flow—a closed position) and the second position (e.g., full flow—an open position) via various intermediate positions (e.g., degrees of reduced flow).

The rotating valve system 100 is configured to adjust and operate in one of multiple operating modes (e.g., to provides different flow rates) and, therefore, is capable of switching between operating modes by selecting and setting a rotational position for each cartridge 118 to achieve a desired flow rate. As the cartridge 118 adjusts its rotational position by rotating about its axis of rotation 120, the amount of flow of fluid 116 through the exit holes 130 and into the manifold 106 (via inlet manifold ports 112) is determined by the overlapping area of the exit holes 130 and the outlet housing port 136 at the flow interface.

The contemplated operating modes include no flow (e.g., complete flow stoppage) via a closed position where there is no overlap between the exit holes 130 and the outlet housing port 136, partial flow via an intermediate position where a reduced fluid flow is allowed due to only partial overlap of the exit holes 130 and the inlet manifold ports 112, and full flow via an open position where the exit holes 130 and the inlet manifold ports 112 are completely aligned, allowing maximum fluid flow into the manifold 106 and to the outside. As best illustrated in FIG. 2c, the changing overlap between the exit holes 130 and the outlet housing port 136 are analogous to a full, waxing, waning, or no moon in shape, with flow volume determined by the cross-sectional area of the overlap at the flow interfaces.

Thus, when in the closed position, the exit holes 130 are not aligned with any of the outlet housing ports 136 to prevent fluid flow therethrough, whereas in the open position, the exit holes 130 are fully aligned with the outlet housing ports 136 to enable fluid flow therethrough. In the intermediate positions, the exit holes 130 are partially aligned with the outlet housing ports 136 to enable partial fluid flow therethrough as a function of the degree of alignment/overlap.

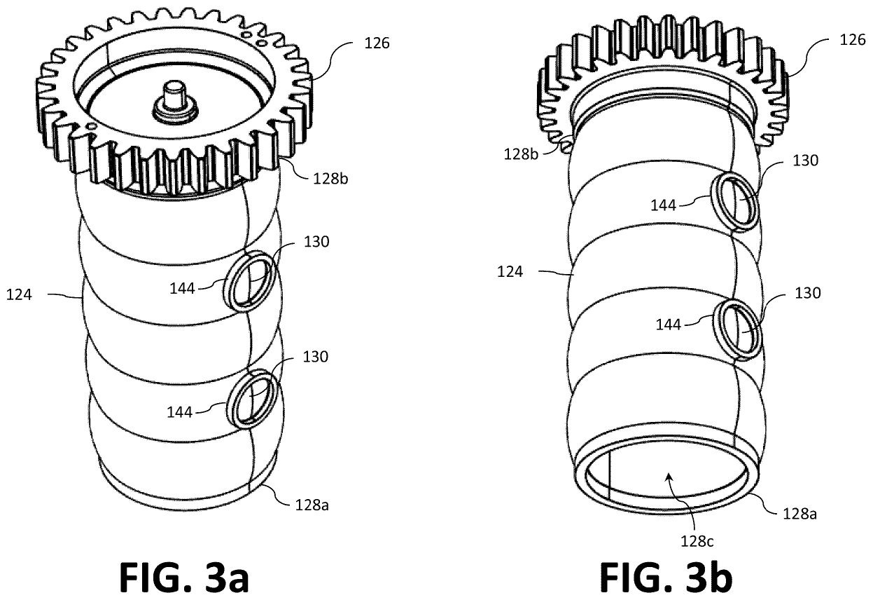

FIGS. 3a and 3b illustrate perspective views of an example cartridge, in accordance with aspects of this disclosure. As illustrated, the cartridge 118 comprises a body portion 124 and a gear portion 126. The body portion 124 defines one or more exit holes 130 and a hollow cavity 128c with an open end 128a and a closed end 128b. Specifically, each cartridge 118 defines a plurality of exit holes 130 positioned in and through a sidewall of the body portion 124.

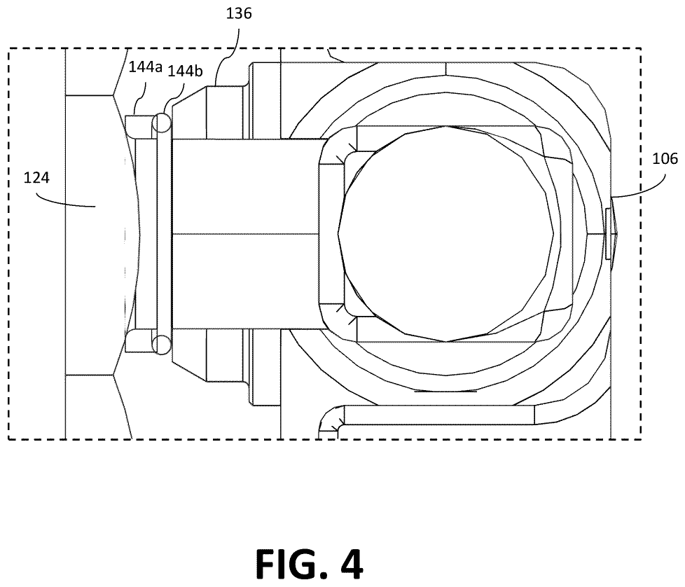

FIG. 4 illustrates a cross-sectional view of the flow interface between the body portion 124 and/or exit holes 130 of a cartridge 118 and an outlet housing port 136 of the housing 104. Depending on the rotational position of the cartridge 118 within the valve cavity 134 of the housing 104, one or more seals 144 can be provided to form a fluid-tight seal is formed between the outlet housing port 136 and the body portion 124 and/or exit holes 130 of a cartridge 118.

In the illustrated example, the one or more seals 144 are provided as a polytetrafluoroethylene (PTFE) ring 144a and an annular ring 144b (e.g., an O-ring). The PTFE ring 144a can traverse a surface of the body portion 124 as the cartridge 118 rotates, while the annular ring 144b is positioned behind the PTFE ring 144a and configured to provide a spring force, thus pushing the PTFE ring 144a against the body portion 124. In other words, the annular ring 144b is configured to provide a spring force that biases the PTFE ring 144a to maintain contact with a surface of the cartridge 118 during rotation thereof. The annular ring 144b may be fabricated from one or more of nitrile butadiene rubber (NBR), ethylene-propylene (EPDM), neoprene (CR), fluorocarbon (Viton), perfluoroelastomers (FFKM) (Parfluor), silicone, thermoplastic vulcanizates (TPV) (e.g., Santoprene™), polypropylene (PP), or a combination thereof

The rotation of the cartridges 118 is driven by the drive assembly 114, which can be controlled via a processor operatively coupled to a memory device. When used in an automobile, the drive assembly 114 can be controlled via the vehicle's electronic control unit (ECU)/electronic control module (ECM). For example, the ECU/ECM may control the cartridges 118 to output a designated second flow rate based on one or more sensor readings, such as thermometers, flow sensors, etc.

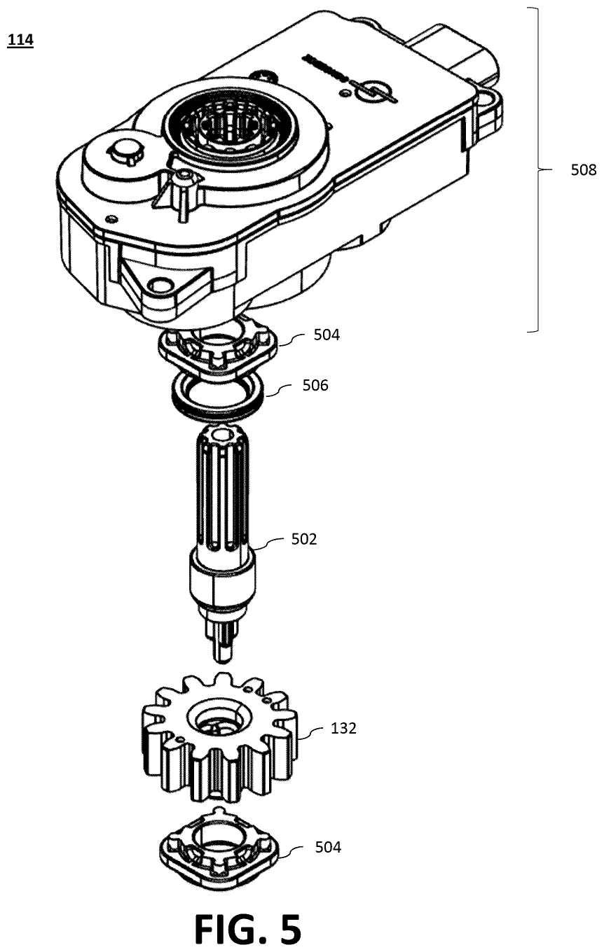

FIG. 5 illustrates an exploded view of an example of an example drive assembly 114. The illustrated drive assembly 114 comprises an actuator 508, a set of bearings 504, a seal 506, a driveshaft 502, and a drive gear 132.

The set of bearings 504 serves to, inter alia, stabilize and reduce friction during rotation of the driveshaft 502 and a drive gear 132, while the seal 506 serves to mitigate infiltration of unwanted liquid and debris into the housing 104. The drive gear 132, when rotated via the driveshaft 502, drives the gear train to rotate each of the cartridge 118 about the axis of rotation 120 to manage the volume of fluid that flows through the rotating valve system 100. The drive gear 132 attaches to and is driven by the actuator 508 via a driveshaft 502. As the actuator 508 turns the drive gear 132, the gear train turns to adjust the position of each cartridge 118. The actuator 508 may be, for example, an electric motor with a housing.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system is not limited to the particular implementations disclosed. Instead, the present method and/or system will include all implementations falling within the scope of the appended claims, both literally and under the doctrine of equivalents.

What is claimed is:

1. A rotating valve system comprising:
a housing defining a valve cavity, wherein the housing includes one or more inlet ports and one or more outlet housing ports;
a valve assembly positioned within the valve cavity and configured to receive fluid via the one or more inlet ports at a first rate and to output the fluid via the one or more outlet housing ports at a second rate,
wherein the valve assembly comprises a plurality of cartridges mechanically engaged with one another and each of the plurality of cartridges being configured to rotate about an axis of rotation between a first position and a second position; and
a drive assembly configured to rotate the plurality of cartridges between the first position and the second position.

2. The rotating valve system of claim 1, wherein each of the plurality of cartridges comprises a body portion and a gear portion.

3. The rotating valve system of claim 2, wherein the body portion defines an inlet port configured to receive the fluid from the one or more inlet ports and at least one exit hole in a sidewall of the body portion configured to deliver the fluid to one of the one or more outlet housing ports.

4. The rotating valve system of claim 3, wherein, when in the first position, the at least one exit hole is configured to not align with any of the one or more outlet housing ports to prevent fluid flow therethrough.

5. The rotating valve system of claim 3, wherein, when in the second position, the at least one exit hole is configured to fully align with one of the one or more outlet housing ports to enable fluid flow therethrough.

6. The rotating valve system of claim 3, wherein each of the plurality of cartridges is configured to rotate between the first position and the second position via an intermediate position and, when in the intermediate position, the at least one exit hole is configured to partially align with one of the one or more outlet housing ports to enable partial fluid flow therethrough.

7. The rotating valve system of claim 1, further comprising a seal positioned at a flow interface between the housing and the cartridge.

8. The rotating valve system of claim 7, wherein the seal comprises a PTFE ring and an annular ring.

9. The rotating valve system of claim 8, wherein the annular ring is configured to provide a spring force that biases the PTFE ring to maintain contact with a surface of the cartridge during rotation thereof.

10. The rotating valve system of claim 1, further comprising a manifold coupled to the housing and configured to receive the fluid via the one or more outlet housing ports.

11. The rotating valve system of claim 1, wherein each cartridge includes a first bearing and a second bearing to support the cartridge during rotation thereof.

12. The rotating valve system of claim 1, wherein the drive assembly comprises an actuator, a driveshaft, and a drive gear, wherein the drive gear is configured to interface with the valve assembly via a gear portion formed in or on one of the plurality of cartridges.

13. The rotating valve system of claim 12, wherein the drive assembly further comprises a bearing and a seal surrounding at least a portion of the driveshaft.

14. A valve assembly configured to receive fluid at a first rate and to output the fluid at a second rate, the valve assembly comprising:
a first cartridge; and
a second cartridge mechanically engaged with the first cartridge,
wherein each of the first cartridge and the second cartridge is configured to rotate about an axis of rotation between a first position and a second position; and
wherein each of the first cartridge and the second cartridge comprises a gear portion and a body portion that defines an inlet port configured to receive the fluid and at least one exit hole in a sidewall of the body portion to deliver the fluid.

15. The valve assembly of claim 14, wherein each cartridge includes a first bearing and a second bearing to support the cartridge during rotation thereof.

16. A rotating valve system comprising:
a housing defining a valve cavity, wherein the housing includes one or more inlet ports and one or more outlet housing ports; and
a valve assembly positioned within the valve cavity and configured to receive fluid via the one or more inlet ports at a first rate and to output the fluid via the one or more outlet housing ports at a second rate,
wherein the valve assembly comprises a plurality of cartridges mechanically engaged with one another and each of the plurality of cartridges being configured to rotate about an axis of rotation between a first position and a second position,
wherein each of the plurality of cartridges comprises a gear portion and a body portion that defines an inlet port configured to receive the fluid from the one or more inlet ports and at least one exit hole in a sidewall of the body portion configured to deliver the fluid to one of the one or more outlet housing ports.

17. The rotating valve system of claim 16,
wherein, when in the first position, the at least one exit hole is configured to not align with any of the one or more outlet housing ports to prevent fluid flow therethrough, and
when in the second position, the at least one exit hole is configured to fully align with one of the one or more outlet housing ports to enable fluid flow therethrough.

18. The rotating valve system of claim 16, wherein each of the plurality of cartridges is configured to rotate between the first position and the second position via an intermediate position and, when in the intermediate position, the at least one exit hole is configured to partially align with one of the one or more outlet housing ports to enable partial fluid flow therethrough.

19. The rotating valve system of claim 16, further comprising a PTFE ring and an annular ring positioned at a flow interface between the housing and the cartridge.

20. The rotating valve system of claim 19, wherein the annular ring is configured to provide a spring force that biases the PTFE ring to maintain contact with a surface of the cartridge during rotation thereof.
